(19) United States
(12) Patent Application Publication
(10) Pub. No.: US 2014/0006078 A1
(43) Pub. Date: Jan. 2, 2014

(54) WORKFLOW MANAGEMENT AND TASK TRACKING

(71) Applicants: William Jason McGauley, Richmond (CA); Daniel Sylvester Rozario, Kanata (CA)

(72) Inventors: William Jason McGauley, Richmond (CA); Daniel Sylvester Rozario, Kanata (CA)

(21) Appl. No.: 12/544,901

(22) Filed: Aug. 20, 2009

(51) Int. Cl. G06Q 10/00; G06F 3/048; G06F 17/30; G06F 15/16; G06Q 10/06

(52) U.S. Cl. 705/7.15; 715/760; 709/204; 707/E17.014; 707/E17.044; 705/7.21; 707/705

(57) ABSTRACT

According to example configurations as described herein, a workflow management application receives a set of interconnected flowchart elements defining a workflow. A particular flowchart element in the workflow represents a task to be jointly executed by one or more resources such as a computer, person, etc. To execute the particular flowchart element, the workflow management application obtains a list. The list can be dynamically generated during execution of the particular flowchart element. The list specifies the multiple users that are to jointly execute the task. The workflow management application can provide notification to the multiple users that the task is to be jointly executed by the multiple users. Additionally, the workflow management application provides, to each of the multiple users, a link to a user interface. The user interface provides further information to the multiple users and indicates details of how to carry out the task.

### BACKGROUND

Conventional software applications enable management of resources via so-called workflows. For example, a computer user can define a workflow application to include a number of individual tasks that are to be executed in a particular order. The workflow can be represented by a sequence of one or more functional blocks in, for example, a flowchart. Each functional block in the workflow can specify a task to be carried out by a single specified person.

During execution of the workflow by a computer, a conventional workflow management application running on the computer can receive feedback such as when a particular functional block or task has been completed by a user. Upon completion of a particular task, the conventional workflow management application can initiate execution of a next task or functional block in the workflow. In this manner, conventional workflow management applications enable sequential execution of multiple different tasks.

To implement a multi-person task according to conventional methods, the workflow can include a number of individual functional blocks disposed in parallel to each other. As mentioned above, each individual functional block can represent a task to be executed by a single person. A combination of parallel functional blocks, each representing a different person, therefore can indicate parallel execution of tasks by multiple persons.

### BRIEF DESCRIPTION

Conventional workflow management applications such as those discussed above suffer from a number of deficiencies. For example, as mentioned above, certain conventional workflow management applications can require a sequential implementation of multiple tasks in a workflow in order to carry out a particular process. Each element in a conventional workflow can represent a step of the workflow to be executed by a single specified person. The presence of multiple functional blocks in parallel, one functional block assigned for each person assigned to the parallel task, can complicate a corresponding flowchart depicting the workflow because a large number of persons and therefore functional blocks may be required to execute a common task in parallel and thus require many individual functional blocks.

In addition to parallel tasks, certain tasks may require input from a group of multiple specified users rather than a single person. As discussed above, conventional workflow management applications can include a number of sequential, individual steps in a workflow to carry out a task by multiple users. Alternatively, as mentioned above, multiple functional blocks in a conventional workflow can be disposed in parallel to represent a task to be jointly executed by the users. However, the parallel set of functional blocks may be cumbersome to create. The parallel set of functional blocks is confusing to a viewer because conventional workflow management applications enable one to specify a particular person to carry out a task.

Embodiments herein deviate with respect to conventional workflow management applications. For example, embodiments herein are directed to unique ways of facilitating workflow management in which a group of specified users carries out a task via a single functional block (i.e., workflow element) in a workflow. Other embodiments herein support a novel way of dynamically generating a list of users that are to jointly execute a task as specified by a workflow element. Yet other embodiments serve other useful purposes as specifically discussed and implied below.

More particularly, one embodiment herein includes a workflow management application operating on a platform such as a computer or, more particularly, a server. The workflow management application receives a set of interconnected flowchart elements defining a workflow to carry out one or more operations. Each flowchart element in the workflow can represent a task to be executed by one or more resources such as a computer, person, etc. At least one of the interconnected flowchart elements can specify a task to be carried out by a number of users or resources.

Assume in this example that, to carry out the workflow, the workflow management application identifies a particular flowchart element in the set of interconnected flowchart elements. The particular flowchart element in this example represents a task to be jointly executed by multiple users.

To execute the particular flowchart element, the workflow management application obtains or creates a list. The list specifies the multiple users that are to jointly execute the task. The workflow management application provides notification to the multiple users in the list indicating that the task is to be jointly executed by the multiple users.

The multiple users can be identified dynamically such as at a time of executing the particular flowchart element rather than at a time of creating the actual workflow. For example, in one embodiment, the workflow management application obtains search criteria specifying characteristics of the multiple users when executing the particular flowchart element. The workflow management application then applies the search criteria to identify the multiple users. In another embodiment, the workflow management application can communicate with an external process to obtain specific information about the multiple users. By way of a non-limiting example, the specific information can include names, addresses, etc., associated with the multiple users that are to jointly execute the task. Accordingly, the list of multiple users and corresponding information can be identified dynamically during execution of the task and workflow.

The workflow management application as discussed above can be implemented in a number of settings. For example, the workflow management application can be executed in a computer such as a network server accessible by multiple clients. The multiple users at the clients can be notified based on communications transmitted from the server over a network to the multiple users. The notification can include an identity or location of a user interface that can be accessed by each of the multiple users to carry out the task.

In one embodiment, the particular element in the workflow identifies subject matter such as a document to be reviewed or approved by multiple persons. Via the user interface accessed by each of the multiple users, the workflow management application can notify the multiple users of a document that is to be jointly reviewed. In such an embodiment, to provide notification of the task, the workflow management application identifies the document as specified by the particular flowchart element. Via the user interface, the workflow management application notifies the multiple users of the particular task such as a document to be jointly reviewed. To carry out the task, the notified users access the user interface.

In addition to identifying a document to be jointly reviewed, the workflow management application also can identify a deadline for completing the task based on the deadline information as specified by the particular flowchart element. Via the user interface accessed by the multiple users, the workflow management application notifies the multiple users of the deadline as a time by which the multiple users are to jointly review the document.

The particular element in the flowchart can include a completion policy specifying conditions that must be met by the multiple users in order to complete the task. The workflow management application obtains the completion policy assigned to a particular flowchart element in the workflow in order to identify conditions in which the task is satisfactorily completed.

In one embodiment, the completion policy specifies a threshold value and specific weighted values for each of the multiple users that are to jointly execute the task. During execution of the task, the multiple users can access the user interface and provide feedback with respect to the document or other subject matter being reviewed. As each user provides feedback, their weight value can be added to a so-called approval value. When the approval value exceeds the threshold value as specified by the completion policy, the workflow management application considers the task to be satisfactorily completed.

These and other embodiment variations are discussed in more detail below.

As mentioned above, note that embodiments herein can include a configuration of one or more computerized devices, workstations, handheld or laptop computers, or the like to carry out and/or support any or all of the method operations disclosed herein. In other words, one or more computerized devices or processors can be programmed and/or configured to operate as explained herein to carry out different embodiments of the invention.

Yet other embodiments herein include software programs to perform the steps and operations summarized above and disclosed in detail below. One such embodiment comprises a computer program product that has a computer-storage medium including computer program logic encoded thereon that, when performed in a computerized device having a processor and corresponding memory, programs the processor to perform the operations disclosed herein. Such arrangements are typically provided as software, code and/or other data (e.g., data structures) arranged or encoded on a computer readable medium such as an optical medium (e.g., CD-ROM), floppy or hard disk or other a medium such as firmware or microcode in one or more ROM or RAM or PROM chips or as an Application Specific Integrated Circuit (ASIC). The software or firmware or other such configurations can be installed onto a computerized device to cause the computerized device to perform the techniques explained herein.

Accordingly, one particular embodiment of the present disclosure is directed to a computer program product that includes a computer readable medium having instructions stored thereon for supporting operations such as managing workflows. The instructions, when carried out by a processor of a respective computer device, cause the processor to: receive a set of interconnected flowchart elements defining a workflow; identify, in the set of interconnected flowchart elements, a particular flowchart element representing a task to be jointly executed by multiple users; obtain a list specifying the multiple users that are to jointly execute the task; and provide notification to the multiple users that the task is to be jointly executed by the multiple users.

The ordering of the steps has been added for clarity sake. These steps can be performed in any suitable order.

Other embodiments of the present disclosure include software programs to perform any of the method embodiment steps and operations summarized above and disclosed in detail below.

Also, it is to be understood that the system, method, apparatus, instructions on computer readable storage media, etc., as discussed herein can be embodied strictly as a software program, as a hybrid of software and hardware, or as hardware alone such as within a processor, or within an operating system or a within a software application. Example embodiments of the invention may be implemented within products and/or software applications such as those manufactured by Adobe Systems Incorporated of San Jose, Calif., USA.

As discussed above, techniques herein are well suited for use in software applications that facilitate execution of workflows and respective tasks by one or more resources. However, it should be noted that embodiments herein are not limited to use in such applications and that the techniques discussed herein are well suited for other applications as well.

Additionally, although each of the different features, techniques, configurations, etc., herein may be discussed in different places of this disclosure, it is intended that each of the concepts can be executed independently of each other or in combination with each other. Accordingly, the one or more present inventions as described herein can be embodied and viewed in many different ways.

Also, note that this preliminary discussion of embodiments herein does not specify every embodiment and/or incrementally novel aspect of the present disclosure or claimed invention(s). Instead, this brief description only presents general embodiments and corresponding points of novelty over conventional techniques. For additional details and/or possible perspectives (permutations) of the invention(s), the reader is directed to the Detailed Description section and corresponding figures of the present disclosure as further discussed below.

### BRIEF DESCRIPTION OF THE DRAWINGS

The foregoing and other objects, features, and advantages of the invention will be apparent from the following more particular description of preferred embodiments herein, as illustrated in the accompanying drawings in which like reference characters refer to the same parts throughout the different views. The drawings are not necessarily to scale, with emphasis instead being placed upon illustrating the embodiments, principles, concepts, etc.

FIG. 1 is an example diagram of a computer environment enabling creation and management of workflows according to embodiments herein.

FIG. 2 is an example diagram illustrating a user interface for creating a workflow according to embodiments herein.

FIG. 3 is an example diagram of a workflow according to embodiments herein.

FIG. 4 is an example diagram of a user interface enabling creation of a completion policy according to embodiments herein.

FIG. 5 is an example diagram of a user interface enabling assignment of multiple users to execute a task according to embodiments herein.

FIG. 6 is a diagram illustrating an example user interface enabling each of multiple users to participate in joint execution of a task according to embodiments herein.

FIG. 7 is a diagram illustrating an example user interface enabling each of multiple users to participate in joint execution of a task according to embodiments herein.

FIG. 8 is a diagram illustrating an example user interface enabling each of multiple users to participate in joint execution of a task according to embodiments herein.

FIG. 9 is a diagram illustrating an example computer architecture for executing a workflow management application according to embodiments herein.

FIG. 10 is a flowchart illustrating an example method according to embodiments herein.

FIGS. 11, 12, and 13 combine to form a flowchart illustrating an example method according to embodiments herein.

FIGS. 14 and 15 combine to form a flowchart illustrating an example method according to embodiments herein.

### DETAILED DESCRIPTION

According to example configurations as described herein, a workflow management application receives a set of interconnected flowchart elements defining a workflow. A particular flowchart element in the workflow represents a task to be jointly executed by one or more resources such as a computer, person, etc. To execute the particular flowchart element, the workflow management application obtains a list of multiple users that are assigned to jointly execute the task. The list can be dynamically generated during execution of the particular flowchart element. In furtherance of executing the particular flowchart element, the workflow management application provides notification to the multiple users that the task is to be jointly executed by the multiple users. The workflow management application can provide, to each of the multiple users, a link to a user interface. The user interface provides further information such as details of how the multiple users can complete execution of the task. Via input from the user interface as provided by the users, the workflow management application keeps track of actions taken by different users towards completion of the task.

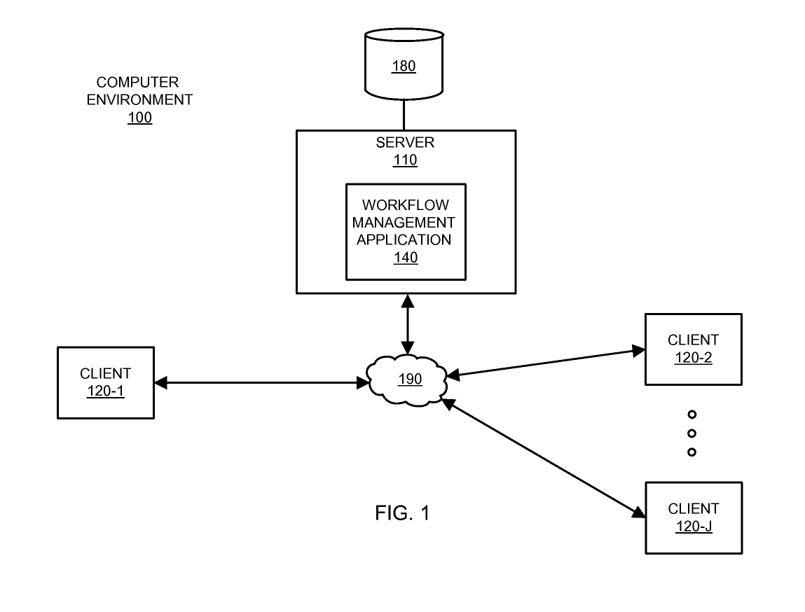

Now, more specifically, FIG. 1 is an example diagram of a computer environment 100 in which a workflow management application 140 enables creation and execution of one or more workflows according to embodiments herein. As shown, computer environment 100 includes clients 120 (e.g., client 120-1, client 120-2, . . . , client 120-J), network 190, repository 180, and server 110 (e.g., a computer system). Clients 120 can represent users and/or computer systems.

During operation, workflow management application 140 enables clients 120 and workflow management application 140 to communicate with each other over network 190 to create workflows. Subsequent to creation of a workflow, the server 110 facilitates execution of the workflow by notifying appropriate clients 120 of their duties to complete a task as specified by the workflow. As will be discussed later in this specification, the workflow management application can keep track of the users jointly executing the task.

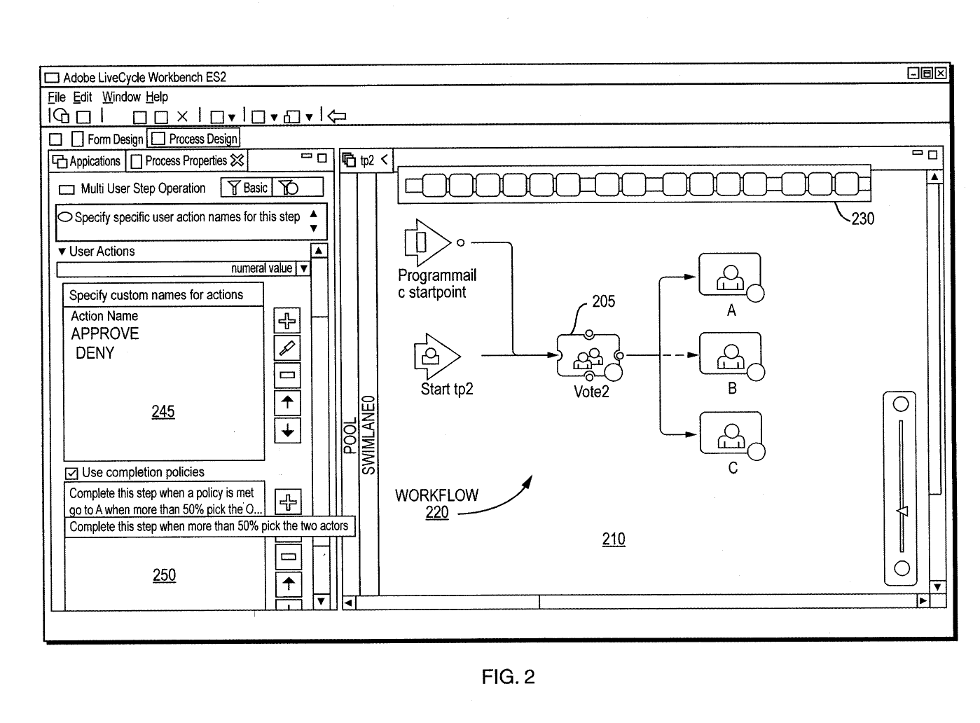

FIG. 2 is an example diagram illustrating a user interface 210 illustrating an example workflow 220 being created by a respective client. For example, assume that client 120-1 opens a respective browser to access user interface 210. Subsequent to receiving a request from client 120-1 to view the user interface 210, the server initiates display of user interface 210 on a respective display screen associated with client 120-1. Client 120-1 selects from menu option of workflow elements 230 to create workflow 220.

Workflow 220 can include a workflow element 205 representing a task in the overall workflow 220 to be jointly executed by multiple users. A portion of user interface 210 can be configured to display completion policy information 250. A user operating user interface 210 provides input to user interface 210 to select an appropriate completion policy for the workflow element 205. More details of selecting a completion policy for a workflow element are discussed later in this specification. In general, the completion policy indicates when a task as represented by the workflow element is satisfactorily completed.

A portion of user interface 210 such as display region 245 can be configured to display names of actions that can be selected by the users that are jointly assigned to execute a task. For example, as shown, in this example embodiment, the user creating the workflow 220 creates an APPROVE action and a DENY action associated with workflow element 205.

Thus, during creation of a workflow, embodiments herein include a workflow management application 140 that initiates display of a multi-user flowchart element (e.g., workflow element 205) in a workflow 220 to represent a task to be jointly executed by a group of multiple users. For the multi-user flowchart element, the workflow management application 140 can collect contact information associated with the multiple users that are to jointly execute the task. Accordingly, as discussed later in this specification, based on the information collected during creation of the workflow, each member in the group can be notified of their duties to jointly execute a respective task in a workflow.

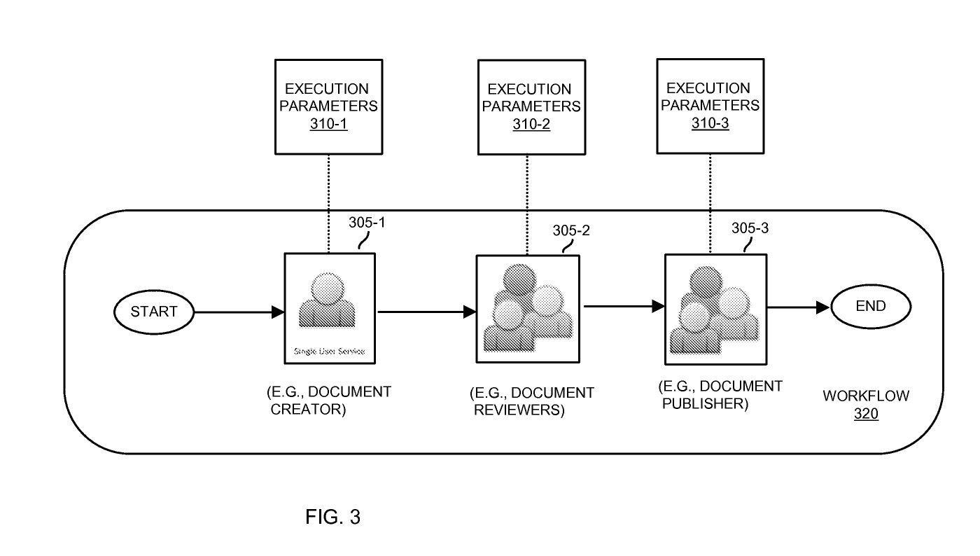

FIG. 3 is an example diagram illustrating an example workflow created via use of user interface 210 according to embodiments herein. In this example embodiment, the client 120-1 selects amongst menu option of workflow elements 230 displayed in user interface 210 to create workflow 320.

By way of a non-limiting example, assume that the client 120-1 defines workflow 320 for creation, review and publishing of a document. To create the workflow 320, the user creates an interconnection of workflow element 305-1, workflow element 305-2, and workflow element 305-3. Each workflow element 305 represents a corresponding task in the workflow to be executed by one or more resources such as person, computers, etc. The client 120 creating the workflow 320 defines execution parameters 310 associated with the workflow 320.

For example, workflow element 305-1 can represent a first task to be executed in the workflow 320. In this example embodiment, workflow element 305-1 represents a task of creating a document by a single person. Via user interface 210, the client 120 creating the workflow 320 defines execution parameters 310-1 associated with workflow element 305-1. As discussed above, the workflow management application 140 collects information from the user creating the workflow 320 and stores such instruction information as execution parameters 310. The execution parameters 310-1 associated with workflow element 305-1 therefore indicate details associated with workflow element 305-1 such as a document creation task represented by the workflow element 305-1, a user in computer environment 100 that is assigned to execute the task, a deadline associated with execution of the task, a completion policy indicating when the task is satisfactorily completed, how to notify the user of the task, one or more user interfaces that can be used by a respective user to complete the task, etc.

Workflow element 305-2 can represent a second task to be executed in the workflow 320. In this example embodiment, workflow element 305-2 represents a task of reviewing the document by a multiple persons. Workflow element 305-2 is a multi-user symbol indicating that the task of reviewing is to be jointly executed by multiple users. Via user interface 210, the client 120 creating the workflow 320 defines execution parameters 310-2 associated with workflow element 305-1. The execution parameters 310-2 associated with workflow element 305-2 indicate details such as a review task represented by the workflow element 305-2, a group of users in computer environment 100 that are assigned to jointly execute the task, a deadline associated with execution of the task, a completion policy indicating when the task is satisfactorily completed, how to notify the users of the task, how to obtain identities of the users that are to jointly execute the task, one or more user interfaces that can be used by the group of users to complete the task, etc.

Workflow element 305-3 can represent a third task to be executed in the workflow 320. In this example embodiment, workflow element 305-3 represents a task of publishing the document. Workflow element 305-3 is a multi-user symbol indicating that the task of publishing is to be jointly executed by multiple users. Via user interface 210, the client 120 creating the workflow 320 defines execution parameters 310-3 associated with workflow element 305-3. The execution parameters 310-3 associated with workflow element 305-3 indicate details such as a publication task represented by the workflow element 305-3, a group of users in computer environment 100 that are assigned to jointly execute the task, a deadline associated with execution of the task, a completion policy indicating when the task is satisfactorily completed, how to notify the users of the task, how to obtain identities of the users that are to jointly execute the task, one or more user interfaces that can be used by the group of users to complete the task, etc.

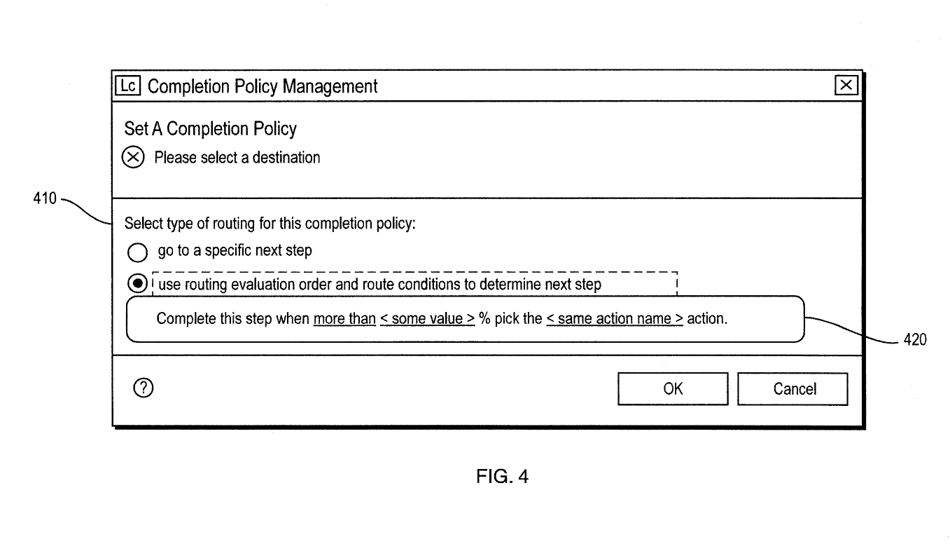

FIG. 4 is an example diagram illustrating a window 410 such as a dialog box associated with user interface 210 for creating a completion policy according to embodiments herein. As shown, the user can create a rule indicating under what circumstances to continue with a next workflow element in the workflow. For example, assume that that the user is creating a completion policy for workflow element 305-2 in workflow 320. Via input with respect to display region 420 of window 410, the user can select a threshold value and conditions when a task is considered to be complete during subsequent execution. When more than a certain number or percentage of persons assigned to jointly execute the task pick a common action such as APPROVAL when executing workflow element 305-2, the current workflow element has been completed and flow continues with the next workflow 305-3.

As previously discussed, the workflow management application 140 stores the completion policy information associated with workflow element 305-2 execution parameters 310-2. Thus, embodiments herein include a workflow management application 140 configured to assign a completion policy to a corresponding workflow element.

In one embodiment, note that in addition to assigning a completion policy to a respective workflow element, the workflow management application can enable a respective user to specify weight information for inclusion in the completion policy. For example, a user can specify weighted values for each of the multiple users that are to jointly execute a respective task. The user can also specify a threshold value. As each user provides feedback such as approval and/or disapproval with respect to a document being reviewed, the workflow management application 140 obtains weight information for each of the persons providing feedback and tallies the weight values for persons providing each type of feedback.

In one embodiment, the workflow management application 140 compares a summation of weight values associated with persons providing a same type of feedback to the threshold value associated with the completion policy. For example, when the sum of weights associated with persons providing a particular type of feedback such as approval of a document is greater than the threshold value, the workflow management application 140 considers the corresponding workflow element to be completed and initiates execution of a next workflow element in the workflow. This embodiment can be useful in situations where it is difficult to get every user to review and provide feedback for a given document. Thus, a creator of the workflow can specify when a task is considered complete. Additionally, completion of a workflow element according to a respective workflow element can occur prior to all participants responding to or participating in the group task.

Thus, embodiments herein provide an automated, computer-implemented way of keeping track of a workflow operation including one or more tasks.

In further embodiments, note that the completion policy associated with one or more workflow elements also can be configured to specify conditions in which the next workflow element in a workflow to be executed by the workflow management application 140 depends on feedback provided for a given workflow element. Thus, a next step executed in a workflow can be one of multiple different possible next workflow elements depending on an outcome of events that occur for a currently executed workflow element.

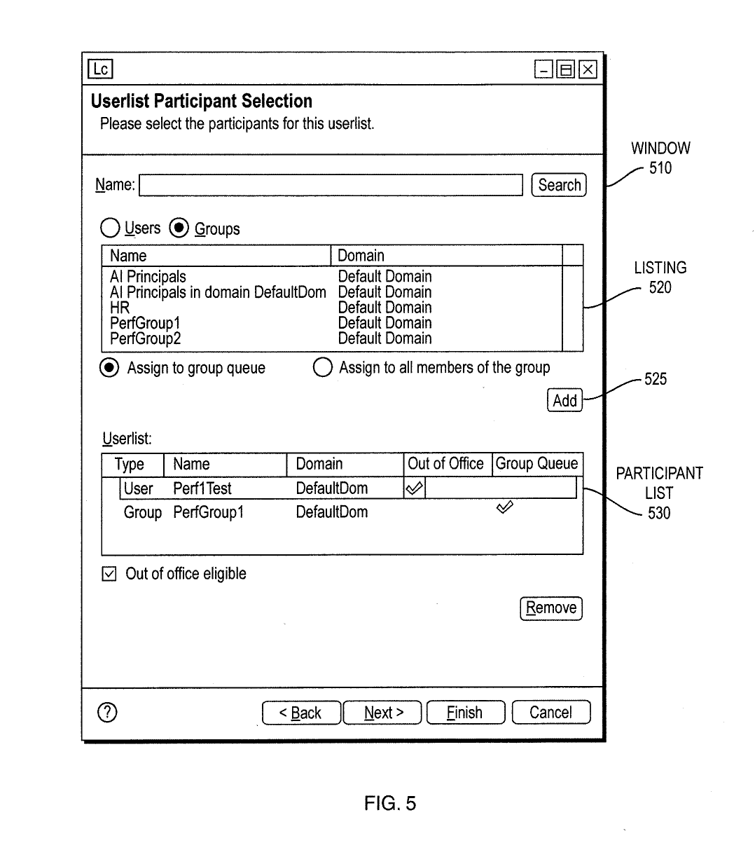

FIG. 5 is an example diagram illustrating a window 510 associated with user interface 210 according to embodiments herein. As shown, window 510 enables a respective user to specify multiple persons that are to jointly execute a respective task.

In this example embodiment, a user can select specific persons and/or names of groups to be included in the group that are to jointly execute the task associated with workflow element 305-2. More specifically, a user can select names of individuals and/or names of groups of persons from listing 520 via ADD button 525. The selected names of individuals and/or groups then appear in participant list 530. The participant list 530 represents the group of persons and/or groups of people that are to jointly execute the task associated with workflow element 305-2.

As previously discussed, the workflow management application 140 stores the participant list information associated with workflow element 305-2 as execution parameters 310-2.

Referring again to FIG. 1, after creation of a workflow as discussed above, the workflow management application 140 initiates execution of a workflow by retrieving the workflow and corresponding execution parameters 310 from repository 180. In this example, assume that client 120-1 creates workflow 320 and initiates execution of the workflow 320 based on a start command sent to workflow management application 140.

In response to the start command to execute the workflow 320, the workflow management application 140 retrieves the workflow 320 and corresponding execution parameters 310 from repository 180. Recall that the execution parameters 310 indicate, for each workflow element, a person and/or or group of persons who are to execute a task associated with a workflow element.

To execute the workflow element 305-1 in workflow 320, and in accordance with the execution parameters 310-1, the workflow management application 140 notifies a particular resource such as a person of the assigned task as represented by a workflow element 305-1. For example, the workflow management application 140 can send an e-mail to the assigned resource to notify the person of the assigned task. The e-mail can include an address or link to a user interface enabling the person to execute the task.

In certain cases, the workflow management application 140 can receive feedback indicating that a particular person assigned a joint task is unavailable or out if the office. The workflow management application 140 can be apprised of the condition by an out of office e-mail response received from a user. In response to detecting that a given user of the multiple users is unavailable to participate in execution of a joint task, the workflow management application 140 can send a communication to a delegate user associated with the given user to enable the delegate user to carry out joint execution of the task on behalf of the given user. The workflow management application can identify the delegate user based on contents of the out of office e-mail (indicating who to contact) or can identify the delegate user from pre-specified information created by a user creating a particular workflow.

Upon completion of the task as specified by the execution parameters 310-1, the workflow management application 140 initiates execution of the workflow element 305-2.

In a similar manner as discussed above, to execute the workflow element 305-2 in workflow 320, the workflow management application 140 notifies multiple persons assigned to execute workflow element 305-2. Notification can include sending e-mails from the workflow management application 140 to the persons assigned to jointly execute the task as represented by workflow element 305-2. For example, the workflow management application 140 can notify client 120-2 with a first e-mail and notify client 120-J via a second e-mail. Each of the e-mails sent from the workflow management application 140 over network 190 to clients 120 can include an address or link to a user interface enabling the client to execute the task.

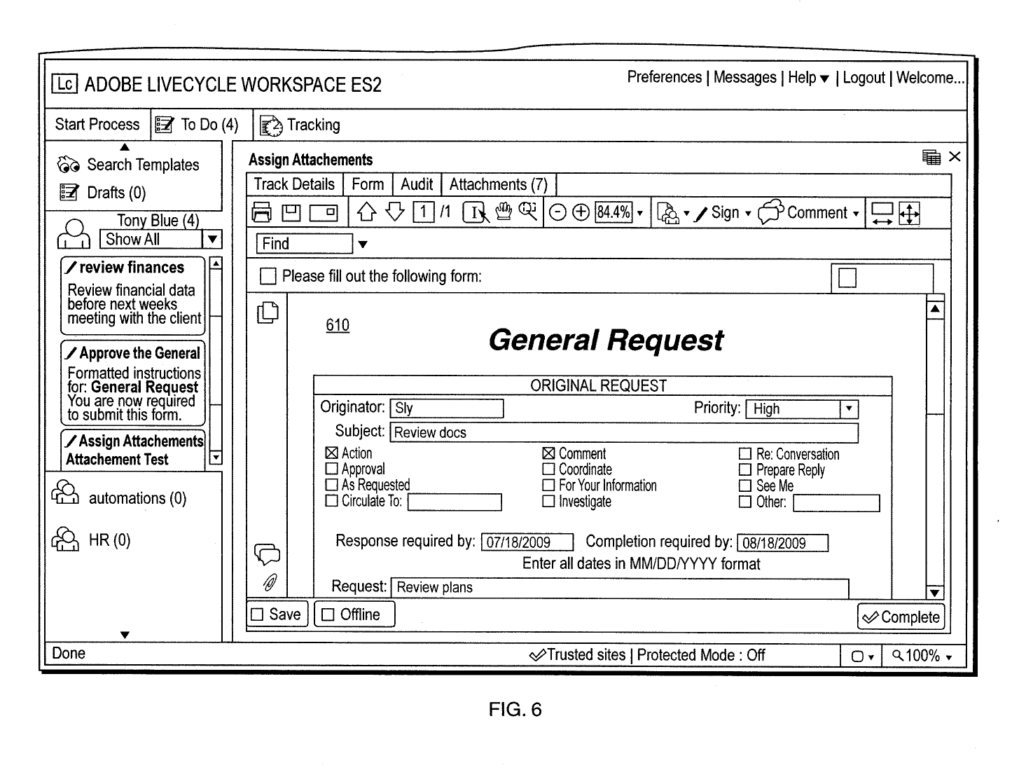

FIG. 6 is a diagram illustrating an example user interface 610 enabling execution of workflow element 305-2 according to embodiments herein.

Assume in this example that each of multiple clients such as client 120-1 and client 120-J in computer environment 100 receives a notification from workflow management application 140 that they are to jointly execute a task. For example, each of such clients 120 can locally open a browser application and use a link in the received notification e-mail to access user interface 610 served by workflow management application 140 to the multiple clients.

Based on information displayed in user interface 610, a respective client assigned to jointly execute the task can be apprised of information such as a deadline for completing the task, a subject matter associated with the task, a priority associated with the task, names of other persons or resources jointly assigned the task, ramifications of failing to complete the task, etc.

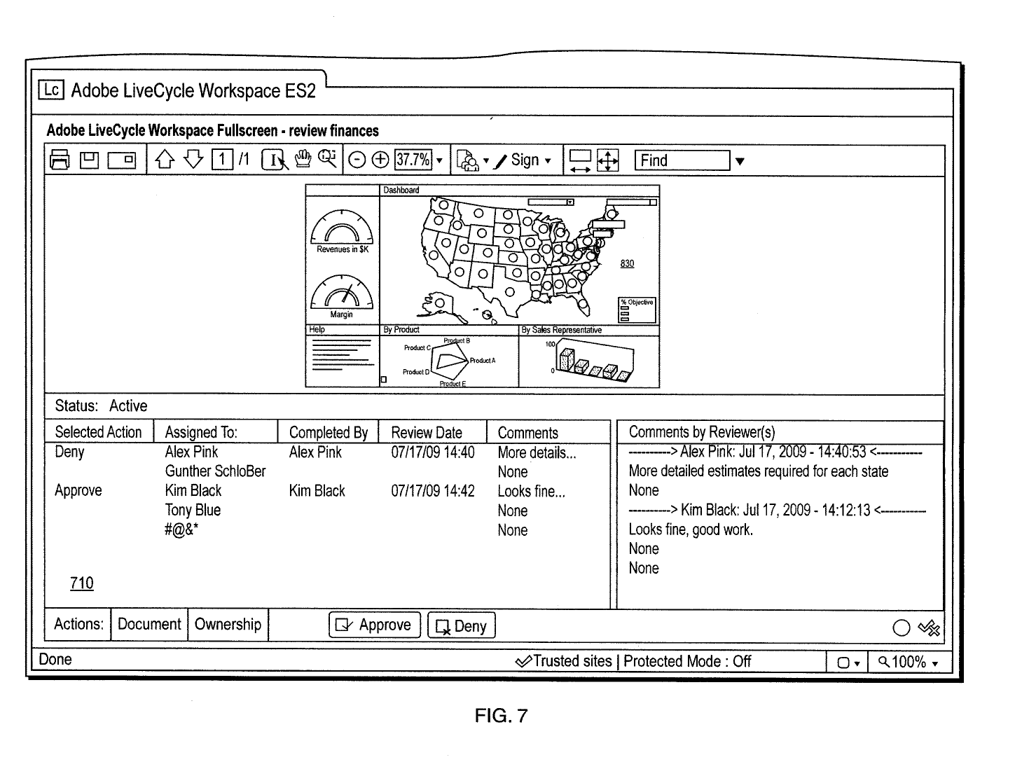

FIG. 7 is a diagram illustrating another example user interface 710 enabling execution of a corresponding workflow element according to embodiments herein.

Assume in this example embodiment that each of multiple clients such as client 120-1 and client 120-J in computer environment 100 receives a notification from workflow management application 140 that they are to jointly execute a task as recited by workflow element 305-2. Each of such clients 120 can locally open a browser application and use a link in the received notification e-mail to access user interface 710 served by workflow management application 140 to the multiple clients. As previously discussed, based on information displayed in user interface 710, a respective client assigned to jointly execute the task can be apprised of information such as a deadline for completing the task, a subject matter associated with the task, a priority associated with the task, names of other persons or resources jointly assigned the task, ramifications of failing to complete the task, etc.

Via user interface 710, the participants assigned to jointly execute the task represented by workflow element 305-2 are able to provide input. For example, each of the users can view and review a respective document, presentation, slideshow, etc., and provide feedback such as approval or disapproval of a reviewed matter. The workflow management application 140 collects the feedback information from multiple participants and via the user interface 710, enables other clients 120 participating in the task to view comments, approval information, disapproval information, etc., by the other participants. More specifically, as shown in user interface 710 retrieved from workflow management application 140, a client can view which participants assigned to jointly execute the task have provided specific comments and those that have not yet provided comments regarding the task.

Note that according to yet further embodiments, the user interface 710 can support additional communications between the different users. For example, a respective user interface operated at a client 120 can include one or more display regions in which a respective user can receive communications from other members assigned to jointly execute the task. A respective user interface operated at a client 120 can include one or more display regions in which a respective user can create and transmit communications to other members assigned to jointly execute the task.

The workflow management application 140 can store and therefore keep track of such communications amongst users via an accessible log. During or after execution of the respective task or workflow, a monitor such as a human administrator can access the log of communications to analyze a progress and cooperation of parties involved in executing the different tasks.

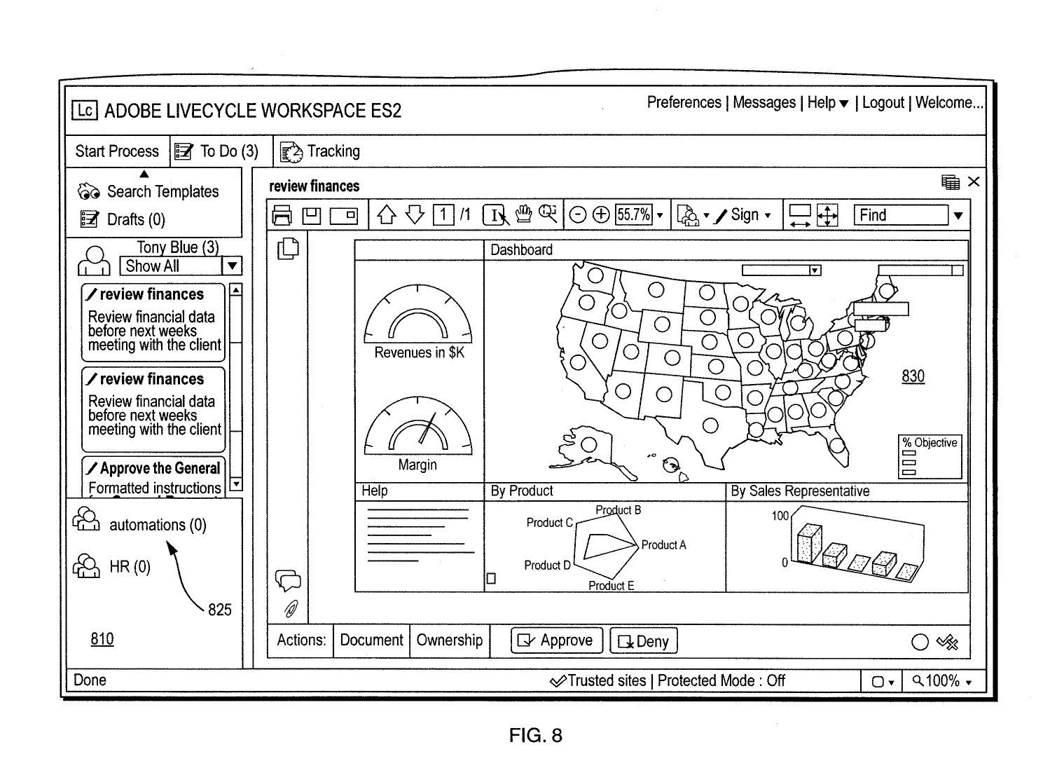

FIG. 8 is a diagram illustrating an example user interface 810 according to embodiments herein. In this example embodiment, the workflow management application 140 populates display region 830 of user interface 810 with financial information to be reviewed by user Tony Blue. By way of a non-limiting example, Tony Blue can retrieve the user interface 810 via a browser operating on a respective client in computer environment 100.

When serving user interface 810, the workflow management application 140 can identify other tasks of other workflows assigned for execution by Tony Blue. In other words, the workflow management application 140 can simultaneously initiate execution of multiple workflows.

The workflow management application 140 can initiate display of personal information in a respective user interface retrieved by the client. For example, Tony Blue may be assigned a task from each of multiple different workflows. Workflow management application 140 populates display region 825 of user interface 830 with status information of the different tasks to be executed by Tony Blue. Accordingly, the user interface 810 also can operate as a way for a respective user to manage multiple tasks that have been assigned to the user.

Because a respective workflow element in a given workflow can represent a task assigned to a single person or a task assigned to a group of persons, the pending tasks displayed in display region 825 for a particular user can represent tasks to be executed by a single user and/or tasks to be jointly executed by a group of users.

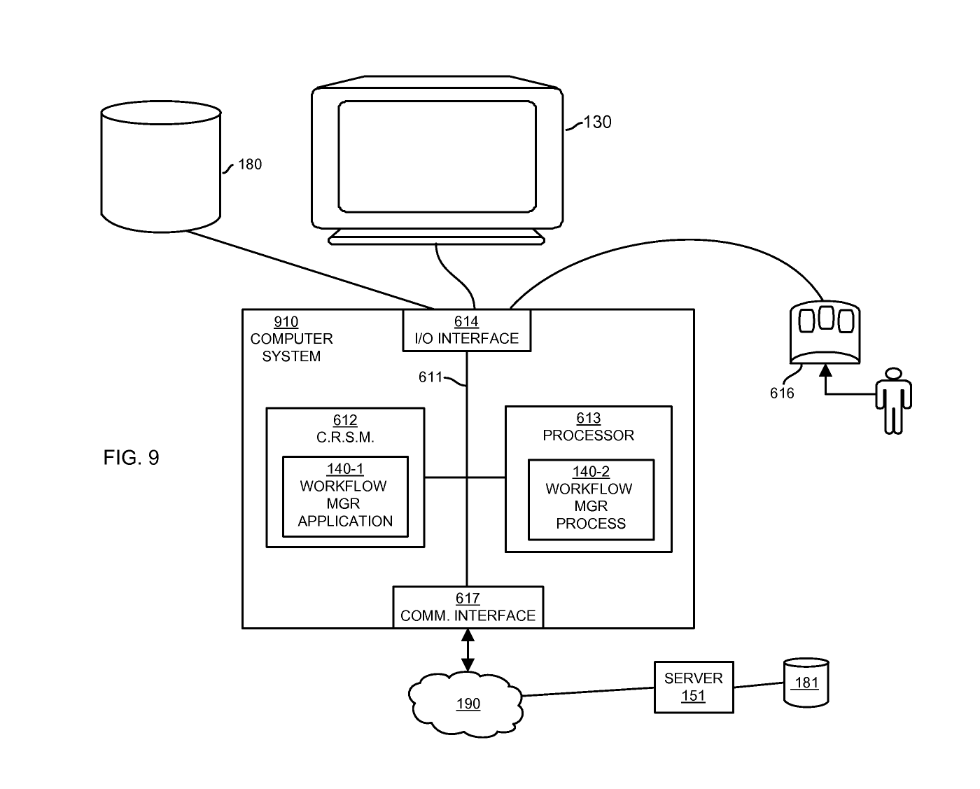

FIG. 9 is a block diagram of an example environment including an architecture of a respective computer system 910 for implementing any functions such as server 110 according to embodiments herein.

Computer system 910 such as a server 110 can be a computerized device such as a personal computer, workstation, portable computing device, console, network terminal, processing device, network device, etc., operating as a server, client, etc.

Note that the following discussion provides a basic embodiment indicating how to carry out functionality associated with workflow management application 140-1. It should be noted that the actual configuration for carrying out the operations as described herein can vary depending on a respective application.

As shown, computer system 910 of the present example includes an interconnect 611 that couples computer readable storage media 612, a processor 613, I/O interface 614, and a communications interface 617. I/O interface 614 provides connectivity to peripheral devices 616, if such devices are present, such as a keyboard, repository 180, a computer mouse, display screen 130, etc.

Computer readable storage medium 612 can be any suitable device to store data such as memory, optical storage, etc.

Communications interface 617 enables computer system 910 and, more particularly, workflow management application 140-1 to communicate over network 190 to retrieve information from remote sources and communicate with clients 120 as described herein. I/O interface 614 also enables the workflow management application 140-1 to retrieve locally stored information from repository 180.

As shown, computer readable storage media 612 can be encoded with workflow management application 140-1 that supports functions as discussed above and as discussed further below. The workflow management application 140-1 can be embodied as software code such as data and/or logic instructions. When executed, the code stored on computer storage media 612 can support processing functionality according to different embodiments described herein.

During operation of one embodiment, processor 613 accesses computer readable storage media 612 via the use of interconnect 611 in order to launch, run, execute, interpret or otherwise perform the logic instructions of the workflow management application 140-1. Execution of the workflow management application 140-1 produces processing functionality in workflow management process 140-2. In other words, the workflow management process 140-2 represents one or more aspects of the workflow management application 140-1 performing within or upon the processor 613 in the computer system 610.

It should be noted that, in addition to the workflow management process 140-2 that carries out method operations as discussed herein, other embodiments herein include the workflow management 140-1 itself such as the un-executed or non-performing logic instructions and/or data. As mentioned, the workflow management application 140-1 may be stored on computer readable storage media 612 such as a floppy disk, hard disk, optical media, etc. According to other embodiments, the workflow management application 140-1 can also be stored on a computer readable storage media such as a memory type system such as in firmware, read only memory (ROM), or, as in this example, as executable code.

In addition to these embodiments, it should also be noted that other embodiments herein include the execution of the functionality as described herein via processor 613. Thus, those skilled in the art will understand that the computer system 910 can include other processes and/or software and hardware components, such as an operating system that controls allocation and use of hardware resources.

As mentioned above, the computer system 910 can support execution of workflow management application 140-1 according to embodiments herein. It should be noted that a similar type of computer architecture with a processor, memory, and executable software instructions can be used to support execution of the clients 120 or other functionality as described herein. Thus, each of clients 120 also can be a computer system configured with computer readable storage medium for storing executable instructions as well as a corresponding processor to retrieve and execute the stored instructions.

Note that the techniques described herein may be implemented by a computer system configured to provide the functionality described. FIG. 9 is thus a block diagram illustrating one embodiment of a computer system 910 configured to implement the methods described herein. In accordance with different embodiments, computer system 1100 may be any of various types of devices, including, but not limited to, a personal computer system, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, or in general any type of computing or electronic device.

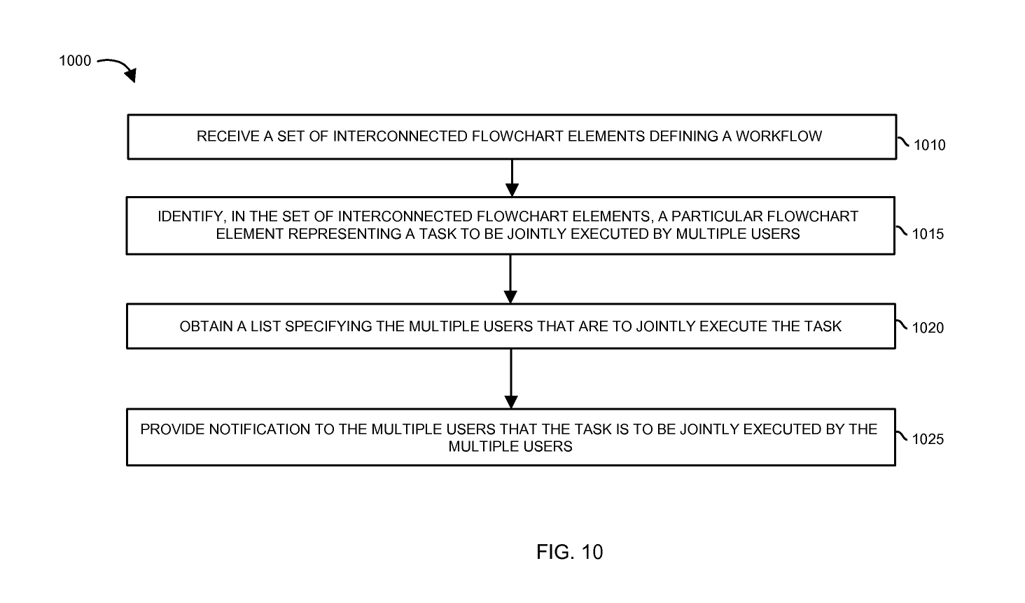

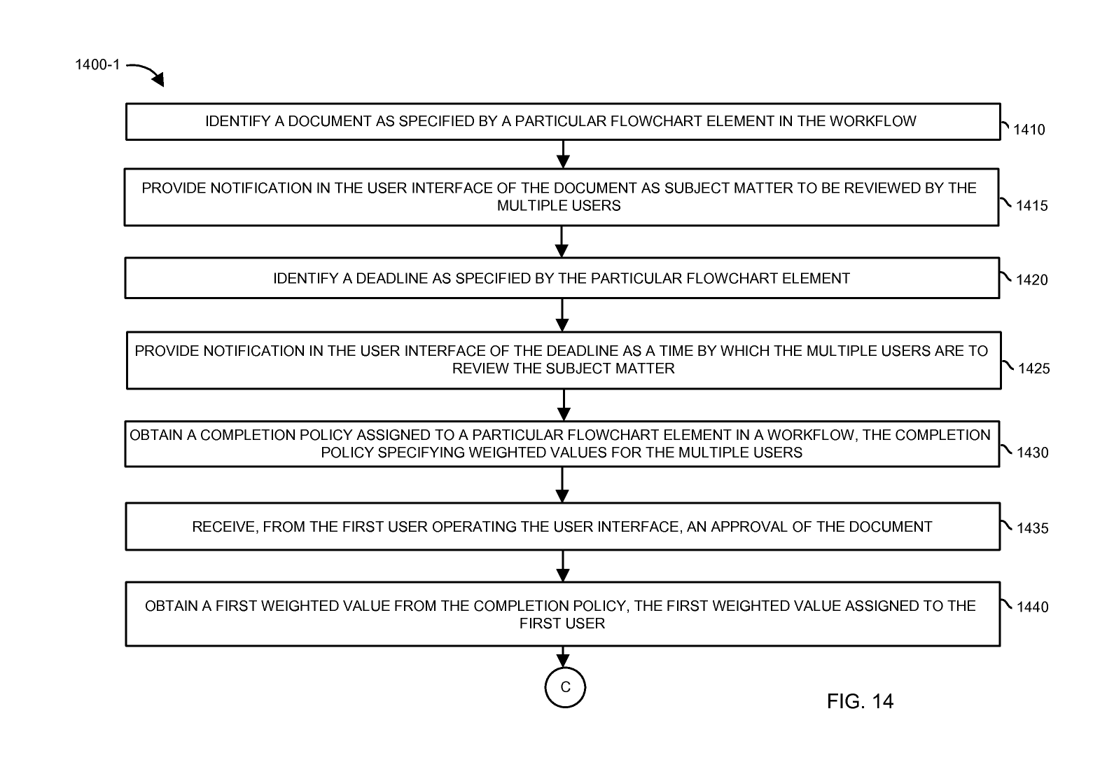

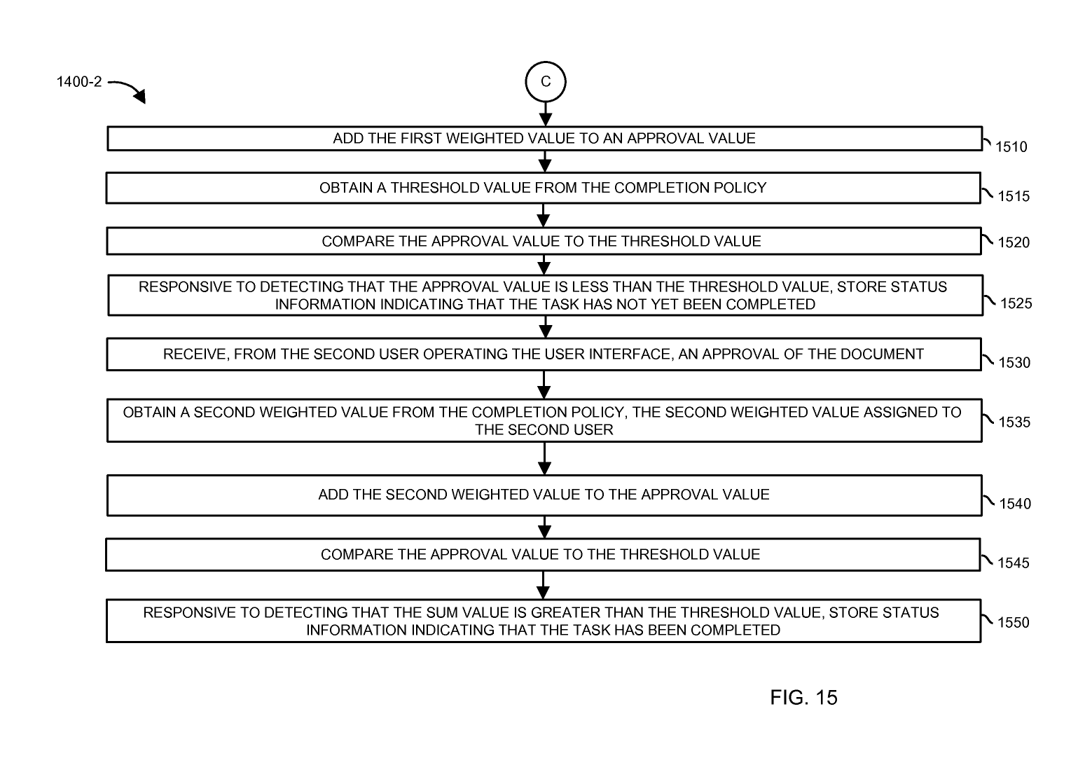

Functionality supported by computer system 910 and, more particularly, functionality associated with the workflow management application 140 will now be discussed via flowcharts in FIGS. 10-15. As discussed above, the workflow management application 140 can be configured to execute the steps in the flowcharts.

Note that there will be some overlap with respect to concepts discussed above for FIGS. 1 through 9. Also, note that the steps in the below flowcharts need not always be executed in the order shown. The steps can be executed in any suitable order.

FIG. 10 is a flowchart 1000 illustrating a technique of managing execution of a workflow according to embodiments herein.

In step 1010, the workflow management application 140 receives a set of interconnected flowchart elements defining a workflow.

In step 1015, the workflow management application 140 identifies, in the set of interconnected flowchart elements, a particular flowchart element representing a task to be jointly executed by multiple users.

In step 1020, the workflow management application 140 obtains a list specifying the multiple users that are to jointly execute the task.

In step 1025, the workflow management application 140 provides notification to the multiple users that the task is to be jointly executed by the multiple users.

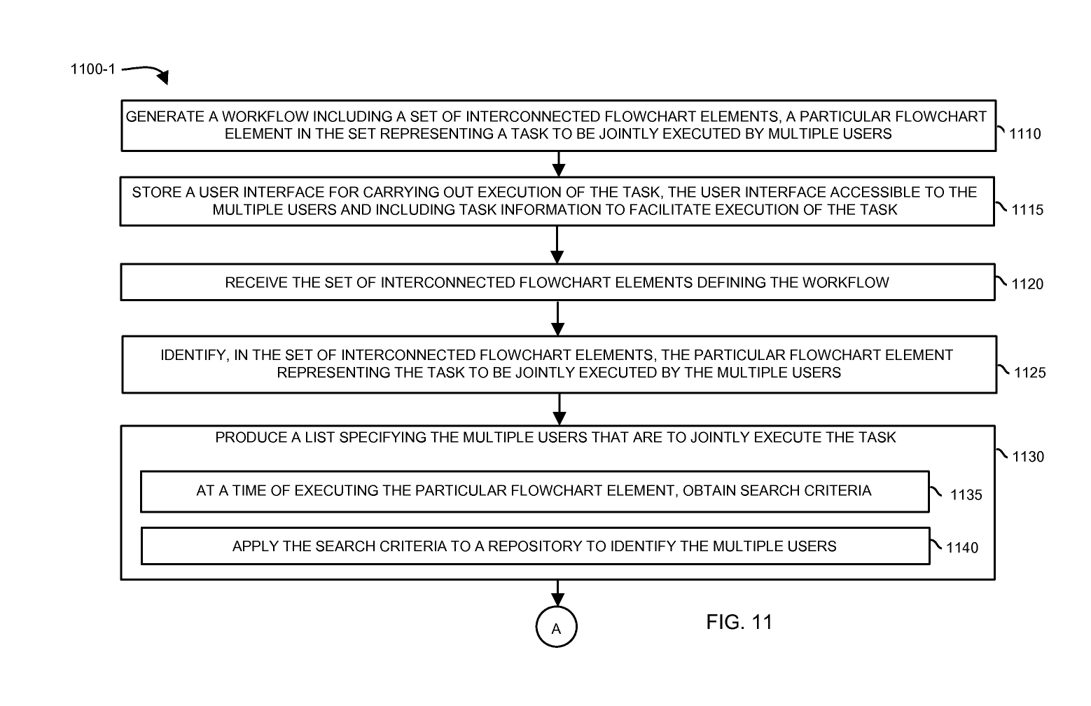

FIGS. 11, 12, and 13 combine to form a more detailed flowchart 1100 (e.g., flowchart 1100-1, flowchart 1100-2, and flowchart 1100-3) illustrating a technique of managing execution of a multi-user functional element in a workflow according to embodiments herein.

In step 1110, the workflow management application 140, based on input from client 120-1, generates a workflow including a set of interconnected flowchart elements. At least one flowchart element (e.g., a multi-user flowchart element) in the workflow represents a task to be jointly executed by multiple users.

In step 1115, the workflow management application 140 stores a user interface for carrying out execution of the task as specified by a multi-user flowchart element in the workflow. The user interface is accessible to the multiple users and provides a way of displaying task information to facilitate execution of the task by the users.

In step 1120, to execute the workflow, the workflow management application 140 receives or retrieves the set of interconnected flowchart elements defining the workflow.

In step 1125, the workflow management application 140 identifies, in the set of interconnected flowchart elements in the workflow being executed, a particular multi-user flowchart element representing a task to be jointly executed by the multiple users.

In step 1130, the workflow management application 140 produces a list specifying the multiple users that are to jointly execute the task. This step can include obtaining execution parameters or instructions associated with the multi-user flowchart element in order to determine how to carry out the task.

In step 1135, at a time of executing the multi-user flowchart element, the workflow management application 140 obtains search criterion. The search criterion specifies characteristics of the multiple users that are to jointly execute the task.

In step 1140, the workflow management application 140 applies the search criterion to a repository to identify the multiple users.

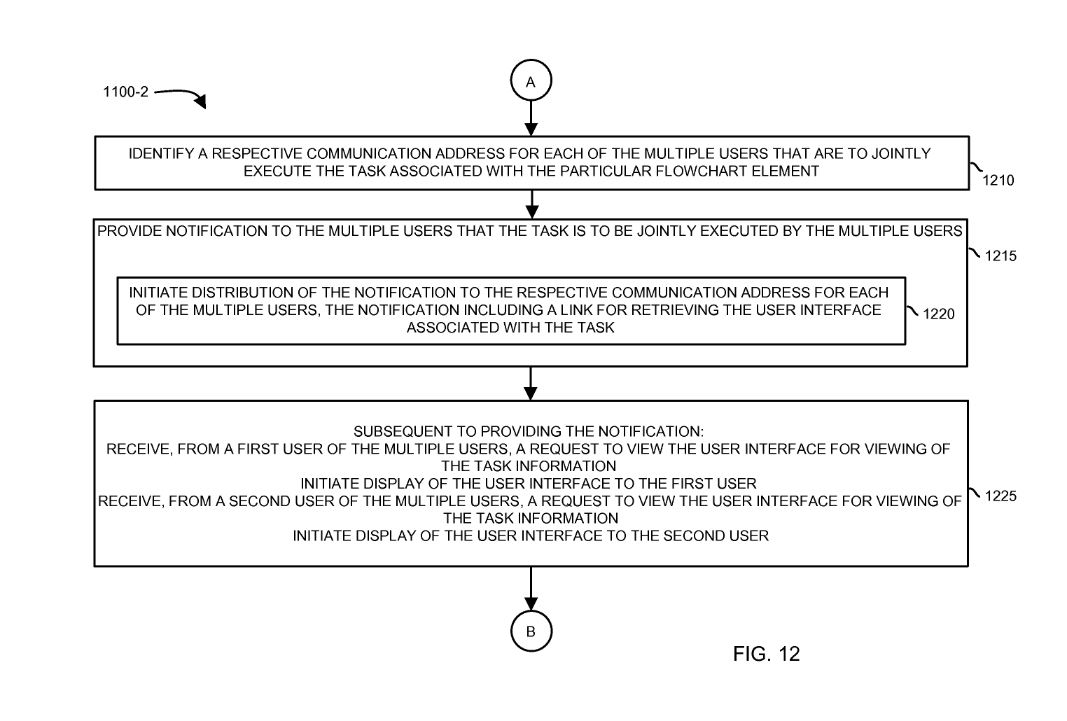

In step 1210 of flowchart 110-2 of FIG. 12, the workflow management application 140 identifies a respective communication address for each of the multiple users that are to jointly execute the task associated with the multi-user flowchart element.

In step 1215, the workflow management application 140 provides notification to the multiple users that the task as represented by the multi-user flowchart element is to be jointly executed by the multiple users.

In step 1220, the workflow management application 140 initiates distribution of the notification to the respective communication address for each of the multiple users.

In one embodiment, the notification can include a link for retrieving the user interface associated with the multi-user flowchart element being executed.

In step 1225, subsequent to providing the notification, the workflow management application:
receives, from a first user (e.g., at client 120-2) of the multiple users, a request to view the user interface for viewing of the task information associated with the multi-user flowchart element;
initiates display of the user interface to the first user;
receives, from a second user (e.g., at client 120-J) of the multiple users, a request to view the user interface for viewing of the task information associated with the multi-user flowchart element; and
initiates display of the user interface to the second user.

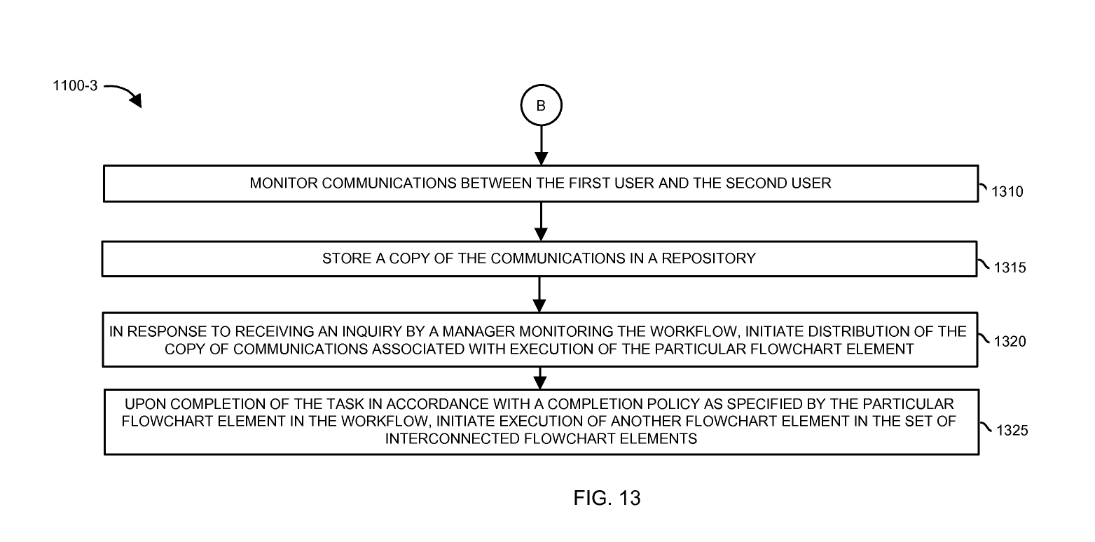

In step 1310 of flowchart 1100-3 in FIG. 13, the workflow management application 140 monitors communications between the first user and the second user.

In step 1315, the workflow management application 140 stores a copy of the communications in a repository.

In step 1320, in response to receiving an inquiry by a manager monitoring the workflow, the workflow management application 140 initiates distribution of the copy of communications associated with execution of the particular flowchart element.

In step 1325, upon completion of the task in accordance with a completion policy as specified by the particular flowchart element in the workflow, the workflow management application 140 initiates execution of another flowchart element in the set of interconnected flowchart elements.

Note again that techniques herein are well suited for management of workflows as described herein. However, it should be noted that embodiments herein are not limited to use in such applications and that the techniques discussed herein are well suited for other applications as well.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While this invention has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting. Rather, any limitations to the invention are presented in the following claims.

1. A computer-implemented method in which at least one computer initiates execution of software instructions to perform steps of:
receiving a set of interconnected flowchart elements defining a workflow;
identifying, in the set of interconnected flowchart elements, a particular flowchart element representing a task to be jointly executed by multiple users;
obtaining a list specifying the multiple users that are to jointly execute the task;
providing notification to the multiple users that the task is to be jointly executed by the multiple users;
obtaining a completion policy assigned to the particular flowchart element, the completion policy specifying conditions that must be completed to complete the task, weighted values for each of the multiple users, and a threshold value;
receiving an approval signifying completion of a condition of the task from a first user of the multiple users that are to jointly execute the task;
determining an approval value based at least in part on the weighted values for each of the multiple users that signified completion of a respective condition of the task;
in the event that the approval value is less than the threshold value, storing status information indicating that the task has not yet been completed; and
in the event that the approval value is greater than the threshold value, storing status information indicating that the task has been completed.

2. The computer-implemented method as in claim 1 further comprising:
storing a user interface for the task, the user interface accessible to the multiple users and including task information associated with the task.

3. The computer-implemented method as in claim 2 further comprising:
in response to detecting that a given user of the multiple users is unavailable, sending a communication to a delegate user associated with the given user to enable the delegate user to carry out joint execution of the task on behalf of the given user.

4. The computer-implemented method as in claim 2, the method further comprising:
subsequent to providing the notification:
receiving, from a first user of the multiple users, a request to view the user interface for viewing of the task information;
initiating display of the user interface to the first user;
receiving, from a second user of the multiple users, a request to view the user interface for viewing of the task information;
initiating display of the user interface to the second user; and
wherein the user interface supports communications between the first user and the second user, the method further comprising:
monitoring the communications between the first user and the second user;
storing a copy of the communications; and
in response to receiving an inquiry by a manager monitoring the workflow, initiating distribution of the copy of communications associated with execution of the particular flowchart element.

5. The computer-implemented method as in claim 1, wherein obtaining the list specifying the multiple users that are to jointly execute the task further comprises:
at a time of executing the particular flowchart element, obtaining search criteria specifying characteristics of the multiple users; and
applying the search criteria to a repository to identify the multiple users.

6. (canceled)

7. The computer-implemented method as in claim 2 further comprising:
identifying a respective communication address for each of the multiple users that are to jointly execute the task associated with the particular flowchart element; and
wherein providing the notification includes initiating distribution of the notification to the respective communication address for each of the multiple users, the notification including a link for retrieving the user interface associated with the task.

8. The computer-implemented method as in claim 7 further comprising:
identifying a document as specified by the particular flowchart element; and
wherein providing the notification includes specifying the document as subject matter to be reviewed by the multiple users.

9. The computer-implemented method as in claim 8 further comprising:
identifying a deadline as specified by the particular flowchart element; and
wherein providing the notification includes specifying the deadline as a time by which the multiple users are to review the subject matter.

10. The computer-implemented method as in claim 1 further comprising:
during creation of the workflow:
initiating display of the particular flowchart element in the workflow to represent the task to be jointly executed by the multiple users; and
for the particular flowchart element, collect contact information associated with the multiple users that are to jointly execute the task.

11. (canceled)

12. The computer-implemented method as in claim 1 further comprising:
storing a user interface for the task, the user interface accessible to the multiple users and including task information associated with the task, the user interface specifying a document to be reviewed for the task;
wherein the receiving an approval signifying completion of a condition of the task from a first user of the multiple users that are to jointly execute the task comprises receiving from the first user operating the user interface approval of the document.

13. (canceled)

14. A non-transitory computer-readable storage medium having instructions stored thereon for processing data information, such that the instructions, when carried out by a processing device, enable the processing device to perform operations of:
receiving a set of interconnected flowchart elements defining a workflow;
identifying, in the set of interconnected flowchart elements, a particular flowchart element representing a task to be jointly executed by multiple users;
obtaining a list specifying the multiple users that are to jointly execute the task;
providing notification to the multiple users that the task is to be jointly executed by the multiple users;
obtaining a completion policy assigned to the particular flowchart element, the completion policy specifying conditions that must be completed to complete the task, weighted values for each of the multiple users, and a threshold value;
receiving an approval signifying completion of a condition of the task from a first user of the multiple users that are to jointly execute the task;
determining an approval value based at least in part on the weighted values for each of the multiple users that signified completion of a respective condition of the task;
in the event that the approval value is less than the threshold value, storing status information indicating that the task has not yet been completed; and
in the event that the approval value is greater than the threshold value, storing status information indicating that the task has been completed.

15. The non-transitory computer-readable storage medium as in claim 14 further including instructions stored thereon that when carried out by the processing device enables operations of:
storing a user interface for the task, the user interface accessible to the multiple users and including task information associated with the task.

16. The non-transitory computer-readable storage medium as in claim 15 further including instructions stored thereon that when carried out by the processing device enables operations of:
subsequent to providing the notification:
receiving, from a first user of the multiple users, a request to view the user interface for viewing of the task information;
initiating display of the user interface to the first user;
receiving, from a second user of the multiple users, a request to view the user interface for viewing of the task information; and
initiating display of the user interface to the second user.

17. The non-transitory computer-readable storage medium as in claim 14, wherein obtaining the list specifying the multiple users that are to jointly execute the task further comprises:
at a time of executing the particular flowchart element, obtaining search criteria specifying characteristics of the multiple users; and
applying the search criteria to a repository to identify the multiple users.

18. (canceled)

19. The non-transitory computer-readable storage medium as in claim 16 further including instructions stored thereon that when carried out by the processing device enables operations of:
wherein the receiving an approval signifying completion of a condition of the task from a first user of the multiple users that are to jointly execute the task comprises receiving from the first user operating the user interface approval of the document.

20. A computer system comprising:
a processor;
a memory unit that stores instructions associated with an application executed by the processor; and
an interconnect coupling the processor and the memory unit, enabling the computer system to execute the application and perform operations of:
receiving a set of interconnected flowchart elements defining a workflow;
identifying, in the set of interconnected flowchart elements, a particular flowchart element representing a task to be jointly executed by multiple users;
obtaining a list specifying the multiple users that are to jointly execute the task;
providing notification to the multiple users that the task is to be jointly executed by the multiple users;
obtaining a completion policy assigned to the particular flowchart element, the completion policy specifying conditions that must be completed to complete the task, weighted values for each of the multiple users, and a threshold value;
receiving an approval signifying completion of a condition of the task from a first user of the multiple users that are to jointly execute the task;
determining an approval value based at least in part on the weighted values for each of the multiple users that signified completion of a respective condition of the task;
in the event that the approval value is less than the threshold value, storing status information indicating that the task has not yet been completed; and
in the event that the approval value is greater than the threshold value, storing status information indicating that the task has been completed.
